(19) United States
(12) Patent Application Publication
(10) Pub. No.: US 2025/0375048 A1
(43) Pub. Date: Dec. 11, 2025

(54) Interactive Playpen

(71) Applicant: Jason Farmer, Modesto, CA (US)

(72) Inventor: Jason Farmer, Modesto, CA (US)

(21) Appl. No.: 18/734,046

(22) Filed: Jun. 5, 2024

(51) Int. Cl. A47D 15/00; A47D 13/06; G06F 3/041; H04N 7/18; H04R 1/02

(52) U.S. Cl. CPC A47D 15/00; A47D 13/06; G06F 3/0416; G06F 2203/04102; H04N 7/18; H04R 1/025

(57) ABSTRACT

An interactive playpen includes a support frame, a bottom panel and four side panels, a touch screen, and a control assembly. The support frame includes a plurality of elongated support elements. The four side panels extend vertically from the bottom panel and are supported by the support frame. The touch screen is mounted on one of the side panels and is designed to display information and images and permit manual interaction by a child in the interactive playpen. The control assembly includes a microprocessor mounted in a housing on one of the side panels and operatively connected to the touch screen.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

### (1) Field of the Invention

The disclosure relates to infant and toddler playpens and more particularly pertains to a new interactive playpen that includes one or more touchscreens in the side panels of the playpen to provide a clutter-free and entertaining environment for infants and toddlers.

### (2) Description of Related Art Including Information Disclosed Under 37 CFR 1.97 and 1.98

The prior art relates to infant and toddler playpens. The prior art, as best understood, does not disclose interactive playpen comprising a child containment assembly having four walls, wherein each wall has a plurality of entertainment attachments and at least one wall includes a touchscreen display and computing device or tablet computer.

### BRIEF SUMMARY OF THE INVENTION

An embodiment of the disclosure meets the needs presented above in a interactive playpen generally comprising a support frame, a bottom panel and four side panels, a touch screen, and a control assembly. The support frame includes a plurality of elongated support elements. The four side panels extend vertically from the bottom panel and are supported by the support frame. The touch screen is mounted on one of the side panels and is designed to display information and images and permit manual interaction by a child in the interactive playpen. The control assembly includes a microprocessor mounted in a housing on one of the side panels and operatively connected to the touch screen.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a interactive playpen according to an embodiment of the disclosure.

FIG. 2 is a rear perspective view of an embodiment of the disclosure.

FIG. 3 is a close-up view of a portion of an embodiment of the disclosure.

FIG. 4 is a top view of an embodiment of the disclosure.

FIG. 5 is a view of an embodiment of the disclosure in use.

FIG. 6 is a block diagram showing the relationship of components of an embodiment of the disclosure.

### DETAILED DESCRIPTION OF THE INVENTION

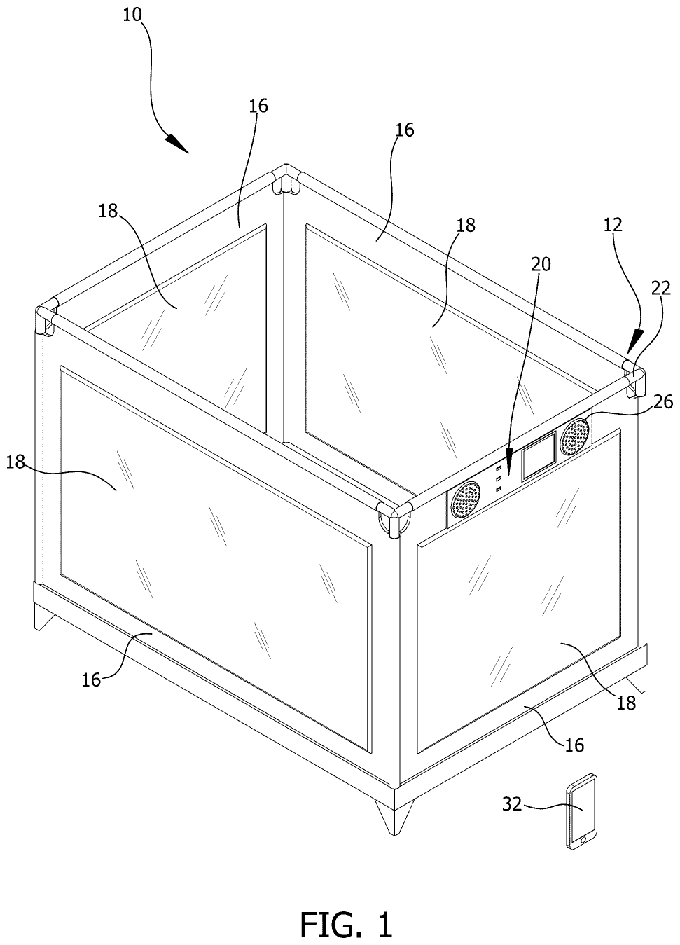

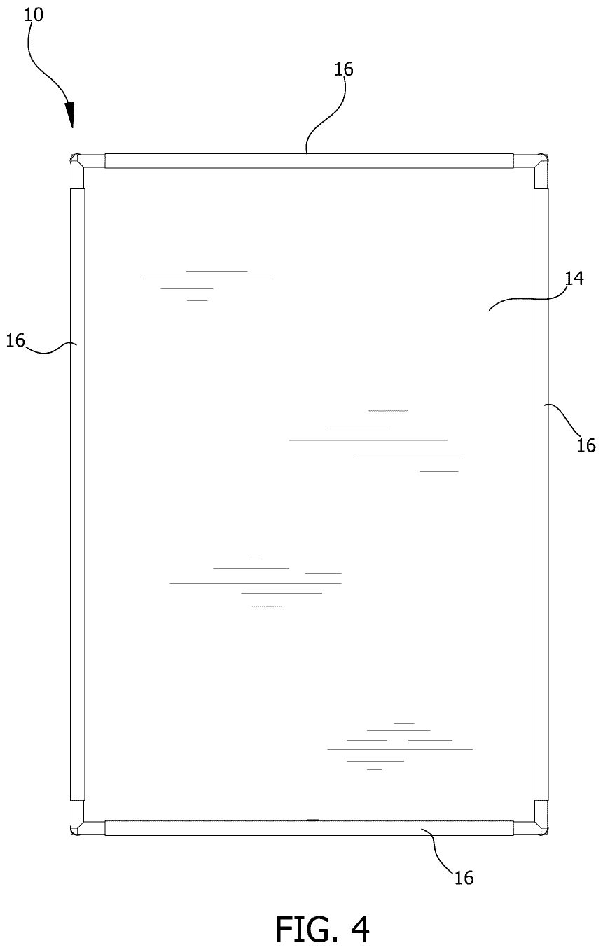

With reference now to the drawings, and in particular to FIGS. 1 through 6 thereof, a new interactive playpen embodying the principles and concepts of an embodiment of the disclosure and generally designated by the reference numeral 10 will be described.

As best illustrated in FIGS. 1 through 6, the interactive playpen 10 generally comprises a support frame 12, a bottom panel 14 and four side panels 16, a touch screen 18, and a control assembly 20. The support frame 12 includes a plurality of elongated support elements 22. The four side panels 16 extend vertically from the bottom panel 14 and are supported by the support frame 12. The touch screen 18 is mounted on one of the side panels 16 and is designed to display information and images and permit manual interaction by a child in the interactive playpen 10. The control assembly 20 includes a microprocessor 24 (not shown) mounted in a housing 26 on one of the side panels 16 and operatively connected to the touch screen 18.

In the exemplary embodiment shown in FIG. 1, the interactive playpen 10 includes a plurality of the touch screens 18, each mounted on a corresponding one of the side panels 16. While four touch screens 18 are shown, the interactive playpen 10 could include three or fewer. Also, in the exemplary embodiment shown in FIG. 1, the touch screen 18 is approximately the same size as its corresponding side panel 16, though smaller sizes are within the scope of the disclosure. In one possible embodiment, the touch screen 18 is a flexible touch screen 18. A flexible touch screen 18 may enhance child safety.

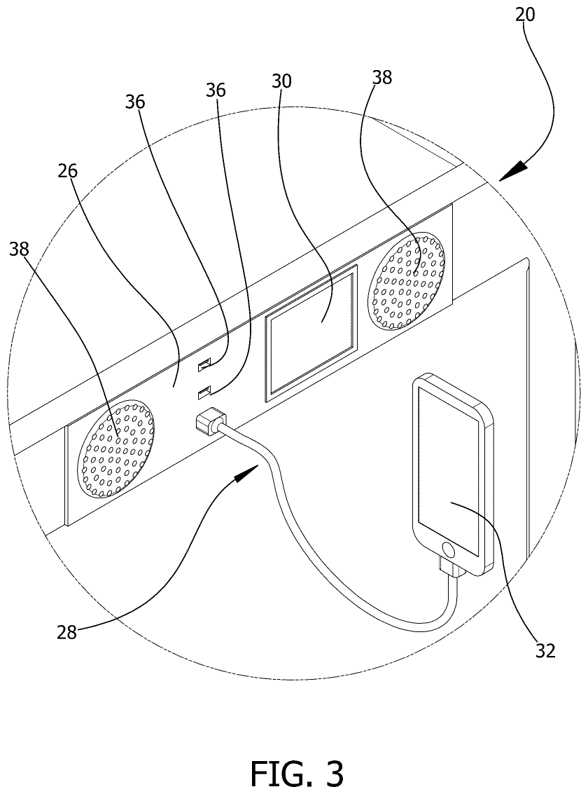

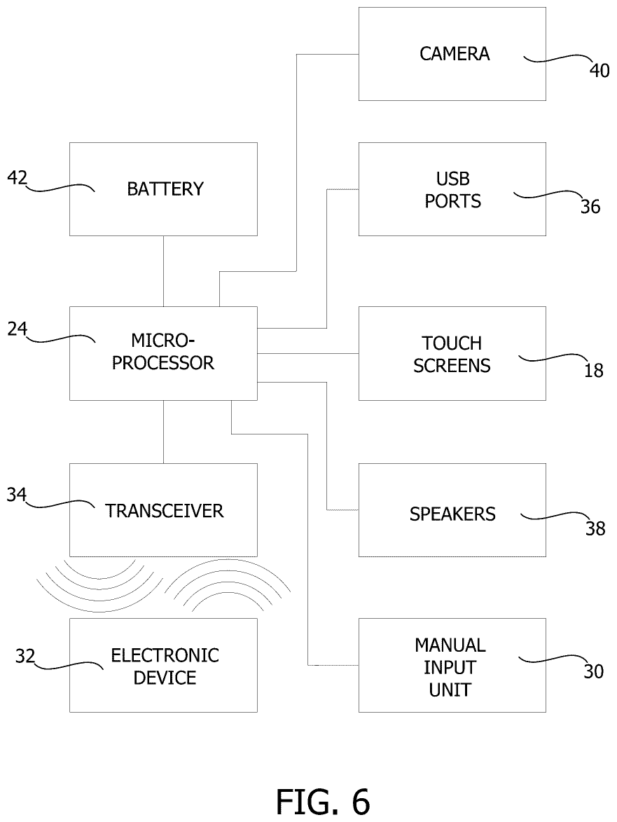

The microprocessor 24 is of a relatively standard design and includes a memory and an operating program to control the operation of the touch screen 18 according to at least one of: pre-programmed data and data input by manual interaction by a child in the interactive playpen 10, as will be discussed further below. The control assembly 20 includes an input interface 28 to permit input of information and control commands by a user. The input interface 28 can be of different designs and combinations thereof. In the exemplary embodiment shown in FIGS. 1 and 3, the input interface 28 includes a manual input unit 30 mounted on one of the side panels 16 and operatively connected to the microprocessor 24. The manual input unit 30 could be a digital screen as shown or include physical buttons or switches or be a combination thereof. The input interface 28 also could include an input program storable on an electronic device 32, such as a remote control or personal electronic device such as a tablet or smartphone, such as shown in FIGS. 1 and 3, and a transceiver 34 (see FIG. 6) operatively connected to the microprocessor 24 and designed to receive input of information and control commands from a user wirelessly via the electronic device 32. The data can be transmitted via a wireless network or near field connection, such as Bluetooth®. The input interface 28 also could include a USB port 36 to permit wired connection with an electronic device 32, as shown in FIG. 3. Essentially any type of input system or device could be used to input commands or data to control the operation of the interactive playpen 10.

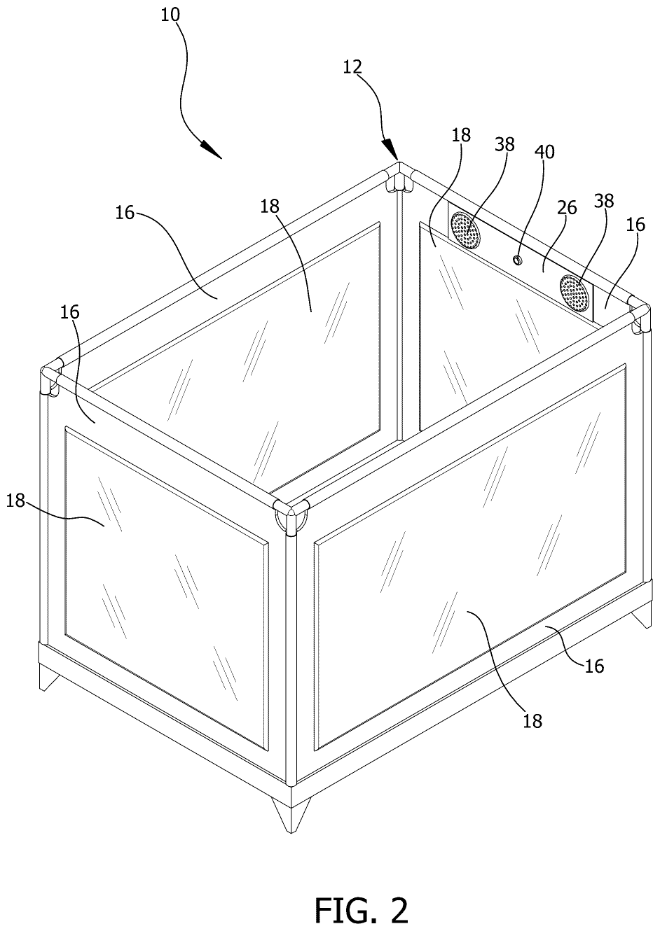

In at least one possible embodiment, the interactive playpen 10 also includes an audio unit mounted on one of the side panels 16 and operatively connected to the microprocessor 24 for control of the audio unit. The audio unit includes at least one speaker 38 designed to output audio. In the exemplary embodiment shown in FIGS. 1 and 2, there are two sets of speakers 38 mounted on the interior and exterior of one of the side panels 16, though other placements and designs are within the scope of the disclosure.

In at least one possible embodiment, the interactive playpen 10 also includes a camera 40 mounted on one of the side panels 16 and operatively connected to the microprocessor 24 for control of the camera 40. The camera 40 is positioned to receive images of an interior of the interactive playpen 10, such as shown in FIG. 1 where the camera 40 is positioned facing the interior of the interactive playpen 10.

The housing 26 can be mounted at a top portion of one of the side panels 16 and can be used to house multiple components of the interactive playpen 10. As shown in FIGS. 1, 2, and 3, the housing 26 houses the audio unit, in this case the speakers 38, the camera 40, the microprocessor 24, the manual input unit 30, and the USB port 36. The housing 26 also houses the transceiver 34 and a battery 42 to supply power, as shown in FIG. 6, which battery 42 can be rechargeable or replaceable.

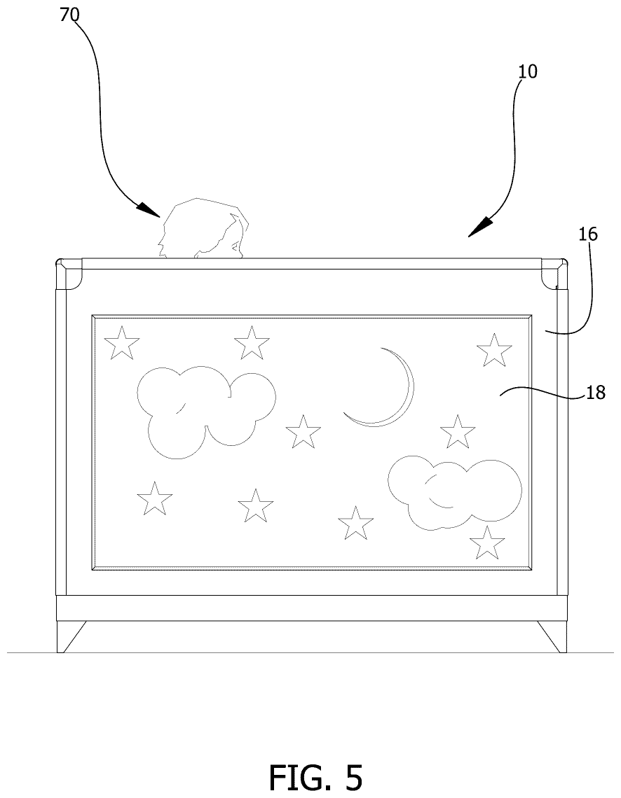

The interactive playpen 10 is used to entertain children in the playpen, such as infants and toddlers. The touch screens 18 can show images and video. A user, such as a parent, grandparent, or other caregiver, can operate the touch screens 18 according to pre-programmed settings, such as to show videos or images and play audio, or can input information to customize what is shown. For example, FIG. 5 shows a nighttime scene including clouds, stars, and a moon, which could be a video or a still image or a series of images. The child 70 in the interactive playpen 10 can manually interact with the touch screens 18 in any known manner, such as manipulating the video or images or inputting information. For example, with reference to FIG. 5, the child 70 could touch the images in the picture and cause the individual elements to move or react or generate a related sound or effect. There is essentially no limit to the various uses possible with the touch screen 18 based on known designs and programming. The USB ports 36 could let the user input video or audio directly. The additional camera 40 could help in monitoring the child 70. It should be understood that the interactive playpen 10 is not limited to the designs and features disclosed herein, and that known variations as to how to electronically input and receive audiovisual information and operate the touch screens 18 are within the scope of the disclosure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interactive playpen comprising:
a support frame comprising a plurality of elongated support elements;
a bottom panel and four side panels extending vertically from said bottom panel and supported by said support frame;
a touch screen mounted on one of said side panels and configured to display information and images and permit manual interaction by a child in the interactive playpen; and
a control assembly comprising a microprocessor mounted in a housing on one of said side panels and operatively connected to said touch screen.

2. The interactive playpen of claim 1, further comprising an audio unit mounted on one of said side panels and operatively connected to said microprocessor for control of said audio unit, wherein said audio unit comprises at least one speaker configured to output audio.

3. The interactive playpen of claim 1, further comprising a camera mounted on one of said side panels and operatively connected to said microprocessor for control of said camera, wherein said camera is disposed to receive images of an interior of the interactive playpen.

4. The interactive playpen of claim 1, wherein the interactive playpen comprises a plurality of said touch screens, each mounted on a corresponding one of said side panels.

5. The interactive playpen of claim 1, wherein said touch screen comprises a flexible touch screen.

6. The interactive playpen of claim 1, wherein said touch screen is approximately the same size as its corresponding side panel.

7. The interactive playpen of claim 1, wherein said microprocessor comprises a memory and an operating program to control the operation of said touch screen according to at least one of: pre-programmed data and data input by manual interaction by a child in the interactive playpen.

8. The interactive playpen of claim 1, wherein said control assembly comprises an input interface to permit input of information and control commands by a user.

9. The interactive playpen of claim 8, wherein said input interface comprises a manual input unit mounted on one of said side panels and operatively connected to said microprocessor.

10. The interactive playpen of claim 8, wherein said input interface comprises an input program storable on an electronic device and a transceiver operatively connected to said microprocessor and configured to receive input of information and control commands from a user wirelessly.

11. The interactive playpen of claim 8, wherein said input interface comprises a USB port to permit wired connection with an electronic device.

12. An interactive playpen comprising:
a support frame comprising a plurality of elongated support elements;
a bottom panel and four side panels extending vertically from said bottom panel and supported by said support frame;
a touch screen mounted on one of said side panels and configured to display information and images and permit manual interaction by a child in the interactive playpen, wherein:
the interactive playpen comprises a plurality of said touch screens, each mounted on a corresponding one of said side panels,
said touch screen comprises a flexible touch screen,
said touch screen is approximately the same size as its corresponding side panel;
a control assembly comprising a microprocessor mounted in a housing on one of said side panels and operatively connected to said touch screen, wherein:
said microprocessor comprises a memory and an operating program to control the operation of said touch screen according to at least one of: pre-programmed data and data input by manual interaction by a child in the interactive playpen,
said control assembly comprises an input interface to permit input of information and control commands by a user, wherein:
said input interface comprises a manual input unit mounted on one of said side panels and operatively connected to said microprocessor,
said input interface comprises an input program storable on an electronic device and a transceiver operatively connected to said microprocessor and configured to receive input of information and control commands from a user wirelessly,
said input interface comprises a USB port to permit wired connection with an electronic device;
an audio unit mounted on one of said side panels and operatively connected to said microprocessor for control of said audio unit, wherein said audio unit comprises at least one speaker configured to output audio;
a camera mounted on one of said side panels and operatively connected to said microprocessor for control of said camera, wherein said camera is disposed to receive images of an interior of the interactive playpen; and
said housing is mounted at a top portion of one of said side panels, wherein said housing houses said audio unit, said camera, said microprocessor, said manual input unit, said transceiver, said USB port, and a battery to supply power.
